(19) United States
(12) Patent Application Publication
(10) Pub. No.: US 2013/0346173 A1
(43) Pub. Date: Dec. 26, 2013

(54) Driving New User Acquisition from Payment Transactions

(71) Applicant: Madhuri Chandoor, San Jose, CA (US)

(72) Inventor: Madhuri Chandoor, San Jose, CA (US)

(73) Assignee: eBay, Inc., San Jose, CA (US)

(21) Appl. No.: 13/532,486

(22) Filed: Jun. 25, 2012

(51) Int. Cl. G06Q 30/02; G06Q 20/20

(52) U.S. Cl. 705/14.17; 705/14.53

(57) ABSTRACT

Systems and methods are disclosed for a payment service provider to provide benefits through provisional accounts established at in-store checkout to consumers who do not have accounts with the payment service provider to drive use sign-up. The payment service provider may offer cash paying consumers electronic cash stored in provisional accounts instead of any change at a point-of-sale, or offer credit card paying consumers a guest checkout experience to receive discounts, incentives, or rewards. The consumers are asked to provide identifying information such as a phone number of their mobile devices. A provisional account is established and linked it to the identification information if the provisional account does not already exist. Otherwise, the payment service provider may verify that the provisional account has not expired. The payment service provider may send reminders to the mobile devices to encourage the consumers to register an account before the provisional account expires.

### TECHNICAL FIELD

The present disclosure relates generally to electronic mobile payment or digital wallet transactions. In particular, the present disclosure presents systems and methods for driving acquisition of new subscribers to mobile payment service provided by payment service providers during in-store checkout.

### BACKGROUND

Mobile payment services offer consumers the convenience of conducting payment transactions using mobile devices. Consumers using mobile devices may conveniently and securely make in-store purchases at checkout counters by authorizing that payments for the purchases be made from the consumers' accounts with a payment service provider. Mobile payment services eliminate the need for the consumers to carry payment instruments such as cash or credit cards—so long as the consumers have established accounts with the payment service provider. As such, consumers who do not have accounts with the payment service provider continue to make payments in the traditional way, such as with cash or credit cards. Currently, there is no easy way for such consumers to sign up with payment service providers during in-store checkout. In addition, the payment service providers may miss an opportunity to tap into a potential pool of new subscribers. Accordingly, there is a need to enable consumers who do not have accounts with payment service providers to experience the benefits of mobile payment services at in-store checkout to drive sign up of new users.

### BRIEF SUMMARY

Systems and methods are disclosed herein to provide benefits through provisional accounts established at in-store checkout to consumers who do not have accounts with a payment service provider to entice the consumers to sign up with the payment service provider. The payment service provider may offer cash paying consumers electronic cash stored in provisional accounts instead of any change at a point of sale. The payment service provider may offer credit card paying consumers a guest checkout experience to receive store discounts. In exchange for the benefits, the consumers are asked to provide identifying information such as the phone number of their mobile device. The benefits may be provided for a limited time or with conditions attached. The payment service provider may send reminders to the mobile devices to encourage the consumers to register an account with the payment service provider. The consumers benefit by having the opportunity to receive benefits provisionally at checkout without holding registered accounts. The payment service provider benefits by having an additional avenue to capture new subscribers.

In accordance with one or more embodiments of the present disclosure, an apparatus of a payment service provider is disclosed. The apparatus includes one or more processors. The apparatus also includes a memory that stores machine-readable instructions for execution by the processors to receive payment transaction information for a purchase made by a user who does not have a registered account with the payment service provider. The apparatus also provides an offer to the user to entice the user to register for an account with the payment service provider. The apparatus further receives identification information from the user. The apparatus further creates or accesses a provisional account linked to the identification info nation received. The apparatus further provides the benefits of the offer to the user. The apparatus further transmits a message to the user based on the identification information to request the user to register an account with the payment service provider.

In accordance with one or more embodiments of the present disclosure, a method of acquiring new users for a payment service provider is disclosed. The method includes receiving by the payment service provider transaction information for a purchase made by a user who does not have a registered account with the payment service provider. The method also includes providing an offer to the user to entice the user to register for an account with the payment service provider. The method further includes receiving identification information of the user. The method further includes creating or accessing a provisional account linked to the identification information. The method further includes providing the benefits of the offer to the user. The method further includes transmitting a message to the user based on the identification information to request the user to register an account with the payment service provider.

In accordance with one or more embodiments of the present disclosure, a non-transitory computer readable medium having machine readable instructions for execution by one or more processors of a device to perform a method is disclosed. The method includes receiving by a payment service provider transaction information for a purchase made by a user who does not have a registered account with the payment service provider. The method also includes providing an offer to the use to entice the user to register for an account with the payment service provider. The method further includes receiving identification information of the user. The method further includes creating or accessing a provisional account linked to the identification information. The method further includes providing the benefits of the offer to the user. The method further includes transmitting a message to the user based on the identification information to request the user to register an account with the payment service provider.

These and other embodiments of the present disclosure will be more fully understood by reference to the following detailed description of the embodiments when considered in conjunction with the accompanying drawings.

### BRIEF DESCRIPTION OF THE DRAWINGS

FIG. 1 shows a user making a payment transaction during in-store checkout using an unregistered account or enjoying a guest checkout experience provided by a payment service provider according to one or more embodiments of the present disclosure;

FIG. 2 shows a flow chart illustrating a method for a user to make a payment transaction with cash using an unregistered account provided by a payment service provider during in-store checkout according to one or more embodiments of the present disclosure;

FIG. 3 shows a flow chart illustrating a method for a user to make a payment transaction with a credit card using a guest checkout experience provided by a payment service provider according to one or more embodiments of the present disclosure; and

FIG. 4 is a block diagram of a computer system suitable for implementing one or more components discussed herein according to one embodiment of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

Systems and methods are disclosed herein to enable consumers who do not have accounts with a payment service provider to receive benefits through provisional accounts established at in-store checkout to encourage the consumers to sign up with the payment service provider. A cash paying consumer at checkout may be offered electronic cash (eCash) stored in an unregistered account instead of receiving any change back from the store. The consumer is asked to provide identification information such as a phone number of a mobile device for the payment service provider to set up the unregistered account and to link the phone number to the unregistered account. After the eCash is deposited into the unregistered account, the payment service provider may transmit a message to the mobile device requesting the user to register an account to claim the eCash. Similarly, a transaction-card paying consumer who makes a payment with a credit card or debit card during checkout may be offered a guest checkout experience through a guest account to enjoy store discounts or other incentives normally reserved for registered account holders of the payment service provider. The consumer may be asked to provide a phone number to enjoy the guest checkout experience. The payment service provider may transmit a message to the mobile device requesting the user to register an account within a time period. Thus, the payment service provider may offer the benefits of eCash or the discounts enjoyed by registered account holders to non-account holding consumers at in-store checkout to entice the consumers to sign up with the mobile payment service.

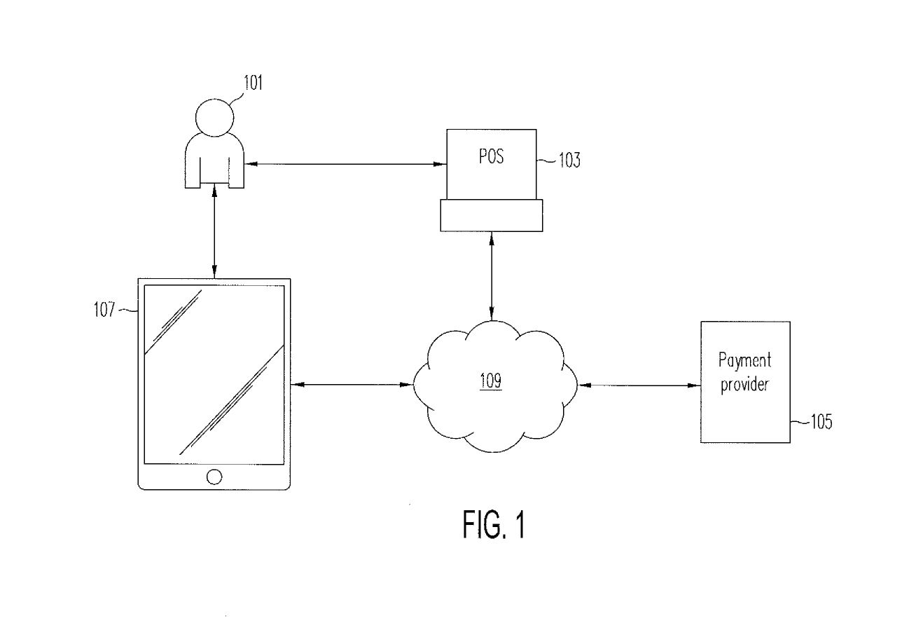

Refer now to the figures wherein the drawings are for purposes of illustrating embodiments of the present disclosure only, and not for purposes of limiting the same. FIG. 1 shows a user making a payment transaction during in-store checkout using an unregistered account or enjoying a guest checkout experience provided by a payment service provider according to one or more embodiments of the present disclosure.

A user 101 makes a purchase at a point-of-sale (POS) terminal 103 in a store. POS terminal 103 is capable of accepting payments using mobile payment services offered by a payment service provider 105 such as PayPal of San Jose, Calif. Users who have registered accounts with payment service provider 105 may request that payments for purchases be made from their accounts to the merchant, giving the users a wallet free checkout experience. If user 101 does not have a registered account with payment service provider 105, payment service provider 105 may offer user 101 the opportunity to try out the mobile payment service through an unregistered account or alternatively through a guest account to create a guest checkout experience for user 101. Payment service provider 105 may be implemented as a computer having one or more processors, memories, communication components, etc. One skilled in the art would understand that the processors of payment service provider 105 may run applications residing in the memories to administer the unregistered accounts and the guest accounts.

In one embodiment, if user 101 is paying by cash, payment service provider 105 may, through POS terminal 103, offer user 101 the option to try out electronic cash (eCash). Under the eCash option, cash change that user 101 receives back from the store is converted into electronic cash and deposited into an unregistered account for user 101. As an enticement for user 101 to try out eCash, the store and/or payment service provider 105 may also offer discounts, incentives, or rewards that are normally offered to customers with registered accounts. If user 101 agrees to the eCash option, POS terminal 103 may request that user 101 provide a phone number of a mobile device 107 of the user for payment provider 105 to establish an unregistered account linked to the phone number. Mobile device 107 may be a smart phone (e.g., iPhone, or other phones running Android, Window Mobile, or other operating systems). Alternatively, POS terminal 103 may request an e-mail address or other identification information from user 101.

POS terminal 103 completes the payment transaction and transmits the amount of the cash change and the phone number to payment service provider 105 through a network 109. In various embodiments, the network may include the Internet, intranets, wireless communication networks (e.g., cellular phone networks, Bluetooth, LAN, WiFi, WiMax), landline networks, and/or other appropriate types of communication networks. Payment service provider 105 may verify if there is already an unregistered account linked to the phone number. If user 101 has previously used eCash, an unregistered account linked to the phone number may already exist and the cash change amount from the current payment transaction is accumulated into the unregistered account. Otherwise, payment service provider 105 establishes an unregistered account linked to the phone number and deposits the cash change as eCash into the account.

Payment service provider 105 may transmit a text message to mobile device 107 through network 109 informing user 101 of the eCash and requesting user 101 to sign up with payment service provider 105 to claim the eCash. The text message may contain a link (e.g., a Uniform Resource Locator (URL) link to an IP address) to facilitate the sign up. When user 101 clicks on the link, user 101 may sign up for a registered account to have eCash transferred from the unregistered account into the registered account. Sign up may include the user providing specific information, such as a bank account or credit card or other funding source, a user identifier (which can be a user name or an e-mail address), and a PIN or password. Note that the phone number may be auto-filled or not requested since the payment service provider already has this information. If user 101 does not immediately sign up, the unregistered account may be held open for a period of time, such as for one month. In other embodiments, the unregistered account may be held open until the eCash balance reaches a certain amount. During this period, user 101 may continue to accumulate eCash by depositing cash change from additional cash payment transactions into the unregistered account. Payment service provider 105 may send periodic reminders requesting user 101 to claim the eCash until user 101 signs up or until the expiration of the time period.

In one embodiment, if user 101 is paying with a transaction card, such as a credit card or a debit card, POS terminal 103 may offer user 101 a guest checkout experience to try out mobile payment services offered by payment service provider 105. As an enticement for user 101 to try out the guest checkout experience offer, the store and/or payment service provider 105 may offer discounts, incentives, or rewards that are normally offered to customers with registered accounts. If user 101 accepts the guest checkout experience offer, POS terminal 103 may request that user 101 provide identification information such as a phone number of a mobile device 107 for payment provider 105 to link a guest account to the phone number. POS terminal 103 may transmit the phone number and information on the payment transaction to payment service provider 105 through network 109.

Payment service provider 105 may verify if there has been a guest account linked to the phone number. If there is, user 101 may have previously received benefits such as discounts, incentives, or rewards using the guest account. Payment service provider 105 may set a limit on the number of times a user may take advantage of the guest account to force the user to sign up. In other embodiments, there may be a limit on the value of the benefits a user may receive during multiple uses of the guest account linked to the same phone number. If the limit is exceeded, payment service provider 105 may request user 101 to register an account or else be denied continued use of the guest account. If the limit has not been exceeded, payment service provider 105 may complete the payment transaction and transmit a payment completion message to POS terminal 103. Payment service provider 105 may update information on the number of times user 101 has taken advantage of the guest account linked to the phone number or the total value of benefits user 101 has received using the guest account linked to the phone number.

If there has not been a guest account linked to the phone number, user 101 is taking advantage of the guest checkout experience linked to the phone number for the first time. Payment service provider 105 may create a guest account, link the guest account to the phone number, complete the payment transaction, and transmit a payment completion message to POS terminal 103. When POS terminal 103 receives the payment completion message, POS terminal 103 may inform user 101 of the benefits user 101 has received, such as discounts, incentives, and rewards normally offered to account holder of payment provider service 105. Note that user paying with cash may be offered these discounts, incentives, and rewards in addition to or alternatively from the eCash option discussed above.

Payment service provider 105 may transmit a text message to mobile device 107 through network 109 requesting user 101 to sign up with payment service provider 105 to continue receiving the benefits. User 101 may sign up for a registered account in the same way as when registering to claim eCash. If user 101 declines to sign up immediately, there may be a limit on the number of times a user may take advantage of the guest account linked to the phone number or a limit on the value of the benefits a user may receive during multiple uses of the guest account linked to the same phone number. Payment service provider 105 may send periodic reminders requesting user 101 to register. If user 101 does not register, payment service provider 105 may reject a future payment transaction using the guest account once the limit is reached.

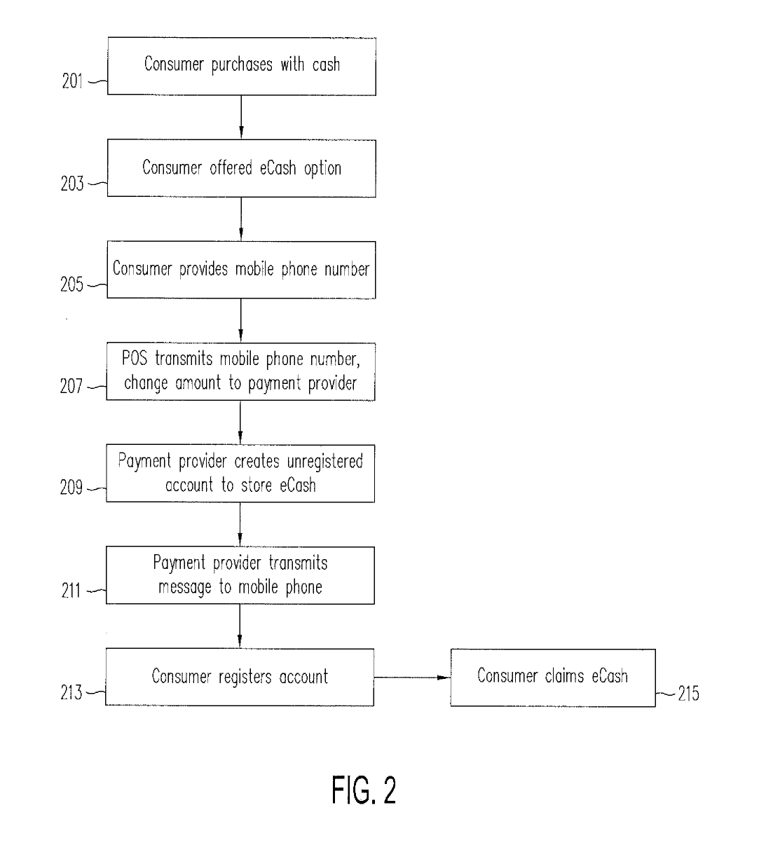

FIG. 2 shows a flow chart illustrating a method for a user to make a payment transaction with cash using an unregistered account provided by a payment service provider during in-store checkout according to one or more embodiments of the present disclosure. In step 201, a consumer who is not a registered account holder of the payment service provider pays with cash at a POS machine during the in-store checkout. The POS machine may transmit information on the payment transaction to the payment service provider. In step 203, the POS machine or the cashier calculates the change, and if there is change due the customer, the POS machine or the cashier offers the consumer the opportunity to have the change deposited as eCash in an unregistered account of the payment service provider. The POS machine may display a message disclosing that to claim the eCash, the consumer needs to register with the payment service provider within a sign-up period. The POS machine may further entice the consumer to try the eCash option by touting the benefits of having a registered account, including the convenience and security of a wallet free checkout experience in the future, or by offering discounts on the payment transaction from the store or the payment service provider.

In step 205, the consumer accepts the eCash option. The POS machine requests the consumer to provide identification information, such as a phone number of a mobile device, an e-mail address, or other unique identifiers that will be linked to the unregistered account to identify the unregistered account as belonging to the consumer. The consumer enters the identification information into the POS machine. In step 207, the POS machine completes the payment transaction and transmits the identification info nation and the change amount to the payment service provider.

In step 209, the payment service provider determines if there is an existing unregistered account linked to the identification information. If an unregistered account linked to the identification information already exists, the consumer has previously accepted an eCash offer using the identification information. The cash change from the current payment transaction is converted into eCash and accumulated to the balance in the unregistered account. The consumer may be notified that there is an existing eCash balance in an unregistered account, that the eCash from the current transaction will be added to that eCash balance, and that the consumer needs to register an account to claim the new balance. In one embodiment, if there is an unregistered account linked to the identification information and carrying an eCash balance, but the unregistered account has expired because the consumer did not register an account to claim the eCash within the sign-up period, the consumer may be offered the opportunity to register at the POS terminal. The consumer may select to register a new account and to transfer the existing eCash balance in the unregistered account and the additional eCash from the current payment transaction to the newly registered account. If, on the other hand, step 209 determines that there is no unregistered account linked to the identification information, the payment service provider establishes an unregistered account linked to the identification information and deposits the cash change as eCash into the unregistered account.

In step 211, after establishing the unregistered account, the payment service provider may transmit a text message or voice to the phone number or may send an e-mail to the e-mail address provided by the consumer in step 205. The text message or voice or e-mail may display or otherwise convey the eCash balance available in the unregistered account for the consumer to claim. The text message or voice or e-mail may also display or convey a reminder to the consumer to register an account before the expiration date, and may display a link that the consumer can click (or other instructions) to go to the website of the payment service provider for account sign-up. In step 213, the consumer clicks on the link or otherwise accesses the website and registers an account with the payment service provider, such as providing any requested information including a user identifier, and a PIN or password. The consumer may add a bank account and/or a credit card number to provide a funding source for the registered account. The consumer may also use the bank account to receive disbursements from the registered account. In step 213, the eCash in the unregistered account may be automatically transferred to the registered account or may be moved by the consumer to the bank account. If the consumer does not register an account, the payment service provider may send periodic reminders to the consumer requesting the consumer to register to claim the eCash. The unregistered account may continue to accumulate eCash from subsequent purchases made by the consumer when the consumer provides the identification information during subsequent checkout. If the consumer does not register within the sign-up period, the unregistered account may expire to stop further accumulation of eCash.

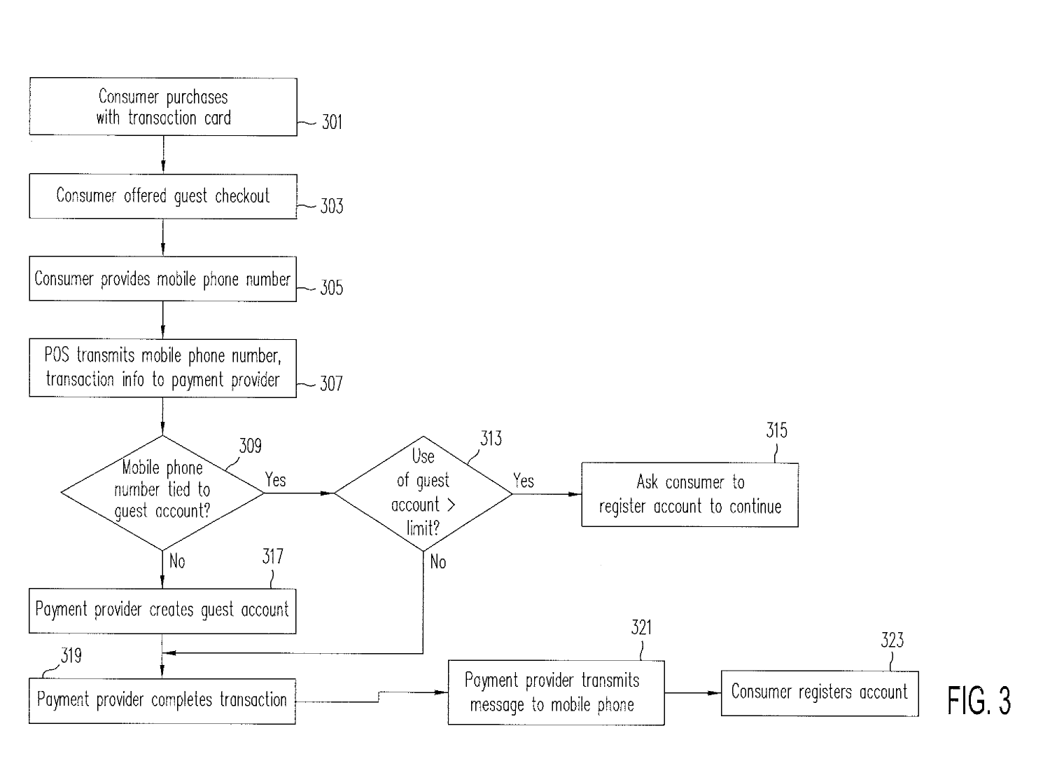

FIG. 3 shows a flow chart illustrating a method for a user to make a payment transaction with a credit card by taking advantage of a guest checkout experience provided by a payment service provider according to one or more embodiments of the present disclosure. In step 301, the consumer who is not a registered account holder of the payment service provider pays with a credit card at a POS machine during in-store checkout. The POS machine may transmit information to the payment service provider indicating that the consumer does not have a registered account. In step 303, the store or the payment service provider offers the consumer benefits such as discounts, incentives, or rewards normally given to customers who are registered account holders if the consumer agrees to try out the guest checkout experience from the payment service provider. The POS machine may display a message touting the benefits of having a registered account, including the convenience and security of a wallet free checkout experience in the future. The POS machine may disclose that the guest checkout experience only lasts for a limited time or that there may be a limit on the value of benefits received.

In step 305, the consumer accepts the offer for the guest checkout experience. The POS machine may request the consumer to provide identification information, such as a phone number of a mobile device, an e-mail address, or other unique identifiers that will be linked to a guest account. The consumer may enter the identification information into the POS machine. In step 307, the POS machine transmits the identification information and information on the payment transaction to the payment service provider. In step 309, the payment service provider determines if a guest account linked to the identification information exists. If it does, the user has previously enjoyed guest checkout experience using the guest account. The user may have received benefits from the store with the guest account. To encourage users who have enjoyed guest checkout experience to sign up, the payment service provider may impose a limit on the duration of the guest account, the number of times it is used, or the value of the total benefits received using the guest account.

In step 313, the payment service provider checks to see if the guest account has reached the limit so as to prevent its continued use. A limit may be reached when the guest account has existed for a duration longer than a maximum time period. In other embodiments, a limit may be reached when the number of times the guest account has been used, or the number of times it will have been used when the current use is included, exceeds a maximum limit. In other embodiments, a limit may be reached when the total value of benefits accrued using the guest account, or the total value of benefits that will have accrued when the value of benefits from the current transaction is included, exceeds a maximum level. If the limit has been reached, the payment service provider may deny the consumer the continued use of the guest checkout experience unless the consumer registers an account. In step 315, the payment service provider requests the consumer to sign up on the POS terminal. In other embodiments, the payment service provider may send a text or voice message to the phone number of the mobile device requesting the consumer to sign up. The text or voice message may display a link that the consumer may click or convey other instructions for the consumer to go to the website of the payment service for account sign-up. If the consumer signs up, such as by providing any requested information including a user identifier, and a PIN or password, the payment service provider completes the payment transaction. Otherwise, the payment service provider sends a message to the POS terminal denying the consumer the continued use of the guest account. The consumer is then unable to receive the discount, incentive, or reward given to registered account holders by the store or the payment service provider.

If step 313 determines that the guest account has not reached the limit for continued use, payment service provider may approve the continued use of the guest account. In step 319, the payment service provider completes the payment transaction and transmits a payment completion message to the POS terminal. The payment service provider may update the number of times the guest account has been used to include the current transaction and may also update the total value of benefits accrued using the guest account to include the value of benefits given for the current transaction.

If step 309 determines that there is no guest account linked to the identification information, then the consumer is taking advantage of the guest checkout experience linked to the phone number for the first time. In step 317, the payment service provider creates a guest account linked to the identification information. In step 319, the payment service provider completes the payment transaction and transmits a payment completion message to the POS terminal. The payment service provider may update the number of times the guest account has been used to one and may store the value of benefits accrued using information received from the POS terminal. In step 321, the payment service provider may periodically transmit a text or voice message to the phone number or may send an e-mail to the e-mail address provided by the consumer in step 305. The text or voice message or the e-mail may display or otherwise convey a reminder to the consumer to register an account, and may provide a link that the consumer can click (or other instructions) to go to the website of the payment service provider for account sign-up. The text message may also display the number of times the guest account has been used and the total value of benefits received using the guest account. In step 323, the consumer clicks on the link or otherwise accesses the website and registers an account with the payment service provider, such as providing any requested information including a user identifier, and a password or PIN. The consumer may add a bank account and/or a credit card number to provide a funding source for the registered account or to receive disbursements from the registered account.

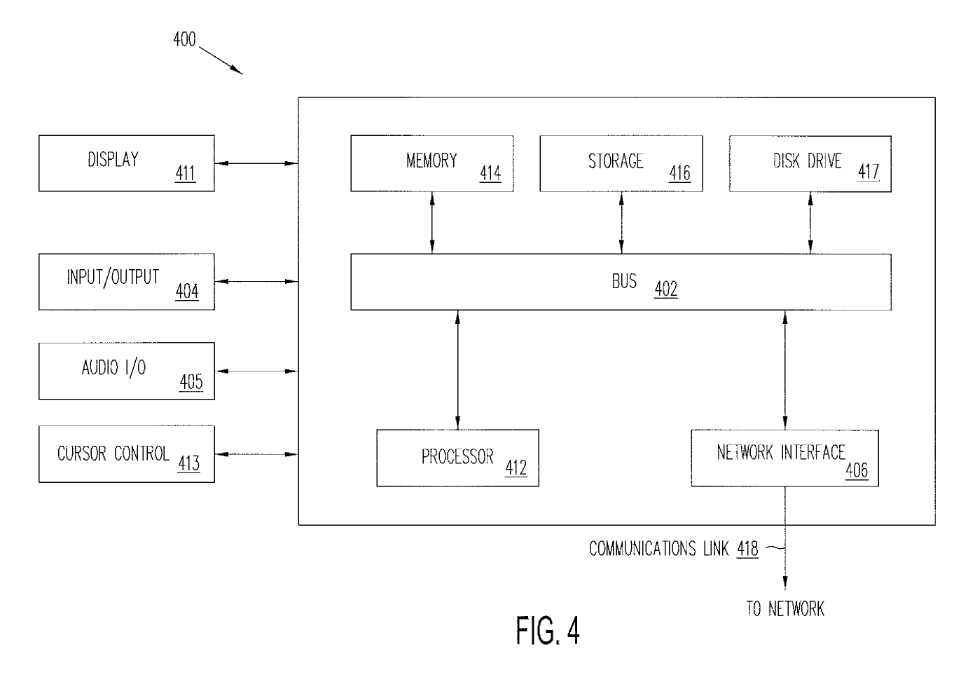

FIG. 4 is a block diagram of a computer system 400 suitable for implementing one or more embodiments of the present disclosure. In various implementations, the mobile device of the user may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component such as a display 411, and an input control such as a cursor control 413 (such as a keyboard, keypad, mouse, etc.). An optional audio input/output component 405 may also be included to allow a user to use voice for inputting information by converting audio signals into information signals. Audio 110 component 405 may allow the user to hear audio. A transceiver or network interface 406 transmits and receives signals between computer system 400 and other devices, such as another user device, a merchant server, or a payment provider server via a communication link 418 to a network. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical, or magnetic disks, or solid-state drives, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Application software in accordance with the present disclosure, such as computer programs executed by a processor of the payment service provider to administer the unregistered account and the guest account, may be stored on one or more computer readable mediums. It is also contemplated that the application software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although embodiments of the present disclosure have been described, these embodiments illustrate but do not limit the disclosure. For example, even though a method is described to give consumers guest checkout experience when making payments with a credit card at in-store POS terminals, the same guest checkout experience may be extended to purchases made on-line, without a POS terminal, or with other types of transaction cards. Similarly, even though a method is described to give cash paying customers an unregistered account to store eCash, the unregistered account may store change from payments made with checks, traveler's checks, or other types of financial instruments. It should also be understood that embodiments of the present disclosure should not be limited to these embodiments, but that numerous modifications and variations may be made by one of ordinary skill in the art in accordance with the principles of the present disclosure and be included within the spirit and scope of the present disclosure as hereinafter claimed.

We claim:

1. An apparatus of a payment service provider comprising:
one or more processor;
a memory adapted to store a plurality of machine-readable instructions wherein the memory is executed by the one or more processors to:
receive payment transaction information for a purchase made by a user, wherein the user does not have a registered account with the payment service provider;
provide an offer to the user to entice the user to register for an account with the payment service provider;
receive identification information of the user;
create or access a provisional account linked to the identification information;
provide benefits of the offer to the user; and
transmit a message to the user based on the identification information to request the user to register an account with the payment service provider.

2. The apparatus of claim 1, wherein the offer is to deposit change owed to the user from a cash or check payment to the provisional account.

3. The apparatus of claim 2, wherein when the user registers the account with the payment service provider, a balance in the provisional account is transferred to the account that is registered.

4. The apparatus of claim 1, wherein the benefits comprise a discount to the user when the user pays for the purchase with a transaction card.

5. The apparatus of claim 1, wherein the provisional account expires when a sign-up period for the user to register the account has expired.

6. The apparatus of claim 1, wherein the payment service provider keeps track of a number of times the provisional account is used and wherein the provisional account expires when the number of times the provisional account is used exceeds a limit.

7. The apparatus of claim 1, wherein the provisional account is accessed if the provisional account linked to the identification information already exists and is created if the provisional account linked to the identification information does not exist.

8. The apparatus of claim 7, wherein if the provisional account linked to the identification information already exists but has expired, the user is requested to register an account with the payment service provider.

9. The apparatus of claim 1, wherein the purchase is made at a merchant point of sale.

10. A method of acquiring new users for a payment service provider, comprising:
receiving by a processor of the payment service provider payment transaction information for a purchase made by a user, wherein the user does not have a registered account with the payment service provider;
providing by the processor an offer to the user to entice the user to register for an account with the payment service provider;
receiving by the processor identification information of the user;
creating or accessing by the processor a provisional account linked to the identification information;
providing by the processor benefits of the offer to the user; and
transmitting by the processor a message to the user based on the identification information to request the user to register an account with the payment service provider.

11. The method of claim 10, wherein the offer comprises depositing change owed to the user from a cash or check payment to the provisional account.

12. The method of claim 11, further comprising transferring by the processor a balance in the provisional account to the account that is registered when the user registers the account with the payment service provider.

13. The method of claim 10, wherein the benefits comprise a discount to the user when the user pays for the purchase by a transaction card.

14. The method of claim 10, wherein the provisional account expires when a sign-up period for the user to register the account has expired.

15. The method of claim 10, further comprising keeping track by the processor a number of times the provisional account is used and wherein the provisional account expires when the number of times the provisional account is used exceeds a limit.

16. The method of claim 10, wherein said creating or accessing by the processor a provisional account linked to the identification information comprises accessing the provisional account if the provisional account linked to the identification information already exists and creating the provisional account if the provisional account linked to the identification information does not exist.

17. The method of claim 16, wherein if the provisional account linked to the identification information already exists but has expired, further comprising transmitting by the processor a request to the user to register an account with the payment service provider before providing benefits of the offer to the user.

18. The method of claim 10, farther comprising, if the user does not register the account with the payment service provider, transmitting by the processor a message to remind the user to register the account.

19. The method of claim 10, wherein said receiving payment transaction information for a purchase comprises receiving payment transaction information for a purchase made at a merchant point of sale.

20. A non-transitory computer readable medium adapted to store a plurality of machine readable instructions which when executed by one or more processors of a device are adapted to cause the device to perform a method, the method comprising:
receiving payment transaction information for a purchase made by a user, wherein the user does not have a registered account with a payment service provider;
providing an offer to the user to entice the user to register for an account with the payment service provider;
receiving identification information of the user;
creating or accessing a provisional account linked to the identification information;
providing benefits of the offer to the user; and
transmitting a message to the user based on the identification information to request the user to register an account with the payment service provider.
